(19) United States
(12) Patent Application Publication
(10) Pub. No.: US 2023/0150695 A1
(43) Pub. Date: May 18, 2023

(54) VEHICLE BODY STRUCTURE AND VEHICLE INCLUDING THE SAME

(71) Applicant: TOYOTA JIDOSHA KABUSHIKI KAISHA, Aichi-ken (JP)

(72) Inventor: Kazuki KOMORIYA, Toyota-shi (JP)

(21) Appl. No.: 18/053,755

(22) Filed: Nov. 9, 2022

(30) Foreign Application Priority Data
Nov. 17, 2021 (JP) 2021-187363

(51) Int. Cl. B64G 1/16; B62D 25/02; B64G 1/56

(52) U.S. Cl. CPC B64G 1/16; B62D 25/02; B64G 1/56

(57) ABSTRACT

A first panel member constituting the outer wall facing the outside of the vehicle, a vehicle body structure having a second panel member. Here, the second panel member, as the space portion is formed between the first panel member, located on the vehicle inside than the first panel member, when the hole in the first panel member is opened, the first panel member by pressure in the vehicle in contact with the member, it is configured to close the hole.

### CROSS-REFERENCE TO RELATED APPLICATION

This application claims priority to Japanese Patent Application No. 2021-187363 filed on Nov. 17, 2021, incorporated herein by reference in its entirety.

### BACKGROUND

### 1. Technical Field

The present disclosure relates to a vehicle body structure and a vehicle including the same.

### 2. Description of Related Art

A lightweight shield for space debris that has a layer structure composed of bumpers arranged at intervals outwardly from the surface of a space structure is known (for example, see Japanese Unexamined Patent Application Publication No. 2011-121476 (JP 2011-121476 A)). In this shield, the layer structure includes at least two or more layers, and at least one of them is a liquid layer filled with liquid. Thus, the protective performance of the lightweight shield for space debris has been improved and the weight thereof has been reduced.

### SUMMARY

However, debris and meteorites tend to fall on planets with thin atmosphere, such as the surface of the moon and the surface of Mars. For example, in a vehicle such as a rover that is equipped with a manned pressurized cabin and that travels and searches on the moon surface or the like, it is conceivable that the debris or meteorite hits the outer wall of the cabin, thereby making a hole in the outer wall. When the hole is large, in particular, the pressure in the cabin suddenly decreases due to the pressure difference between the inside and outside of the vehicle, which threatens the life of the occupants in the cabin.

Thus, increasing the thickness of the outer wall of the cabin was considered. However, in this case, another problem arises that the weight of the vehicle such as a rover increases. Thus, for the vehicle such as a rover used on planets with thin atmosphere, such as the surface of the moon and the surface of Mars, there is still room for improvement in a structure for suppressing decrease in the protective performance of the panel member constituting the outer wall that faces outside the vehicle while reducing the weight of the panel member.

An object of the present disclosure is to provide a vehicle body structure and a vehicle including the same.

A vehicle body structure according to a first aspect of the present disclosure includes:

a first panel member constituting an outer wall that faces outside a vehicle; and
a second panel member that is positioned on a vehicle inner side of the first panel member such that a space is provided between the first panel member and the second panel member and that is configured, when a hole is made in the first panel member, to come into contact with the first panel member with a pressure inside the vehicle to close the hole.

With the above configuration, when a hole is made in the first panel member constituting the outer wall that faces outside the vehicle, the second panel member positioned on the vehicle inner side of the first panel member comes into contact with the first panel member with the pressure inside the vehicle and the second panel member closes the hole. Therefore, decrease in the protective performance of the first panel member is suppressed. Further, as compared with a case of ensuring the protective performance of the first panel member by making the plate thickness thicker, it is possible to reduce the weight of the first panel member.

In the vehicle body structure according to the first aspect, the second panel member may include a protective film made from resin.

With the above configuration, it is possible to reduce the weight of the second panel member, as compared with the case where the second panel member is composed of an iron plate, for example.

The vehicle body structure according to the first aspect may further include a liquid layer provided on a vehicle outer side of the second panel member.

With the above configuration, when the hole is made in the first panel member and the second panel member is about to contact the first panel member with the pressure inside the vehicle, the liquid layer comes into contact with the first panel to close the hole. Therefore, decrease in the protective performance of the first panel member is suppressed.

A vehicle according to a second aspect of the present disclosure includes the above vehicle body structure and is configured to be used on a ground surface other than Earth.

With the above configuration, even when a hole is made in the first panel member in the case where the vehicle is used on the ground surface other than Earth, the hole is automatically closed by the second panel member. Thus, it is not necessary for occupants to go out of the vehicle and perform the work of closing the hole.

As described above, according to the present disclosure, it is possible to reduce the weight of the panel member constituting the outer wall that faces outside the vehicle while suppressing decrease in the protective performance of the panel member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing a rover having a vehicle body structure according to the present embodiment;

FIG. 2A is an X-X arrow schematic sectional view of FIG. 1 showing a state in which a hole is opened in the first panel member by debris;

FIG. 2B is an X-X arrow schematic sectional view of FIG. 1 showing a state in which the opening hole in the first panel member is closed by the second panel member;

FIG. 3 is a schematic sectional view showing an enlarged configuration of the second panel member;

FIG. 4A is an X-X arrow schematic sectional view of FIG. 1 showing a state in which a hole is opened in the first panel member by debris;

FIG. 4B is an X-X arrow schematic sectional view of FIG. 1 showing a state in which the open hole in the first panel member is closed by a liquid layer (adhesive);

FIG. 5A is an X-X arrow schematic sectional view of FIG. 1 showing a state in which a hole is opened in the first panel member by debris; and

FIG. 5B is an X-X arrow schematic sectional view of FIG. 1 showing a state in which the opening hole in the first panel member is closed by a liquid layer (ice).

### DETAILED DESCRIPTION OF EMBODIMENTS

Hereinafter, embodiments according to the present disclosure will be described in detail with reference to the drawings. Incidentally, for convenience of explanation, the vehicle upward direction arrow UP shown as appropriate in each figure, the vehicle forward direction arrow FR, the vehicle right direction arrow RH. Thus, when terms indicating directions, i.e., upward and downward, forward and rearward, and right and left are used in the following description without any specification, these mean upward and downward of the vehicle seat, forward and rearward of the vehicle seat, and right and left of the vehicle seat. The left-right direction is synonymous with the vehicle width direction.

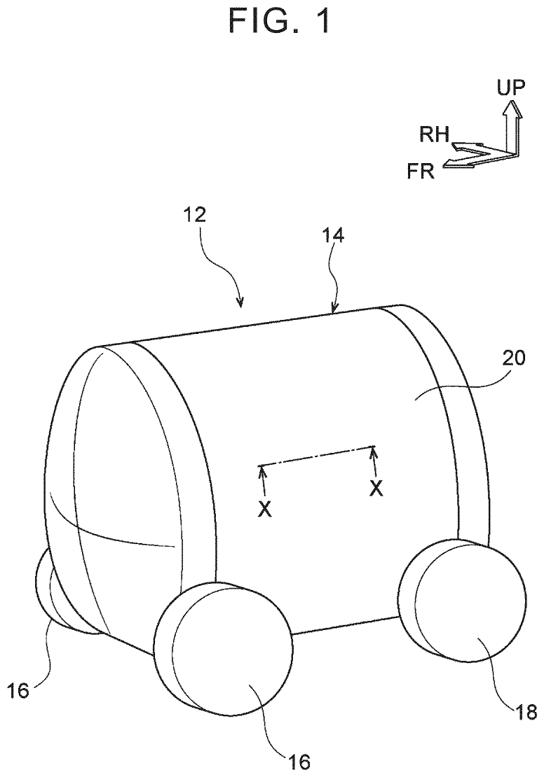

As shown in FIG. 1, the vehicle having the vehicle body structure 10 according to the present embodiment (see the diagram 2A, diagram 2B) is a vehicle used mainly on the surface other than the Earth, such as the surface of the moon or the surface of Mars, a thin planet of the atmosphere. Specifically, a rover 12 that travels and searches on a lunar surface or the like is exemplified. Rover 12 includes a cabin 14 which is pressurized constituting the vehicle cabin occupied by the occupant, a pair of left and right front wheels 16 provided in the front lower portion of the cabin 14, a pair of left and right rear wheels 18 provided in the rear lower portion of the cabin 14, and a.

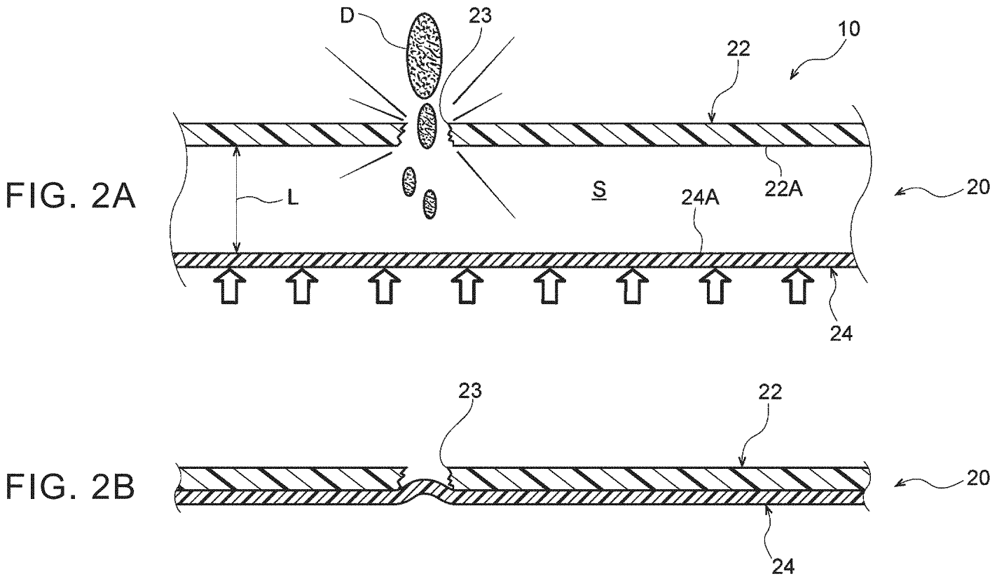

As shown in FIG. 2A, the panel member 20 covering the cabin 14 includes a first panel member 22 constituting the outer wall facing the vehicle outside, a second panel member 24 located on the vehicle inside than the first panel member 22, it is composed of. The second panel member 24 is configured such that a space portion S, which will be described later, is formed between itself and the first panel member 22.

The second panel member 24, the pressure of the vehicle interior (in the cabin 14) is always biased to the first panel member 22 side (indicated by white arrows). The second panel member 24 is configured to be located on the entire vehicle inside of the first panel member 22 is not limited to its configuration, such as the arrangement of the units in the cabin 14, a portion thereof may be partially omitted.

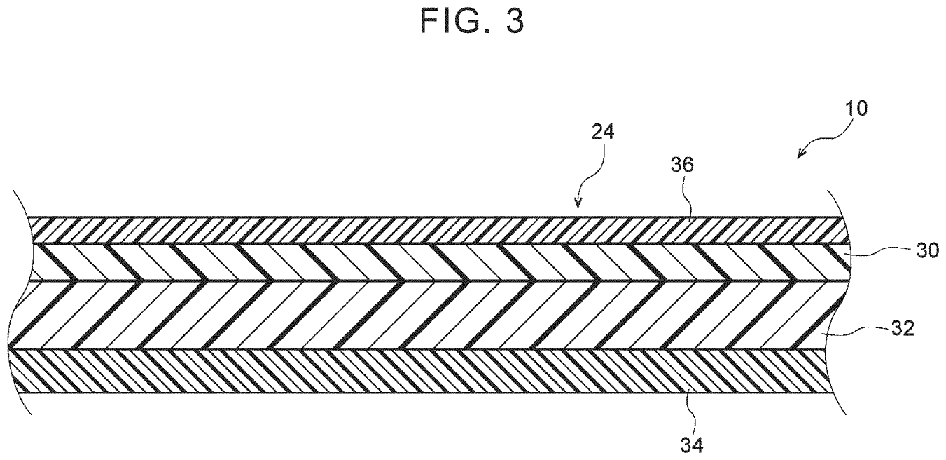

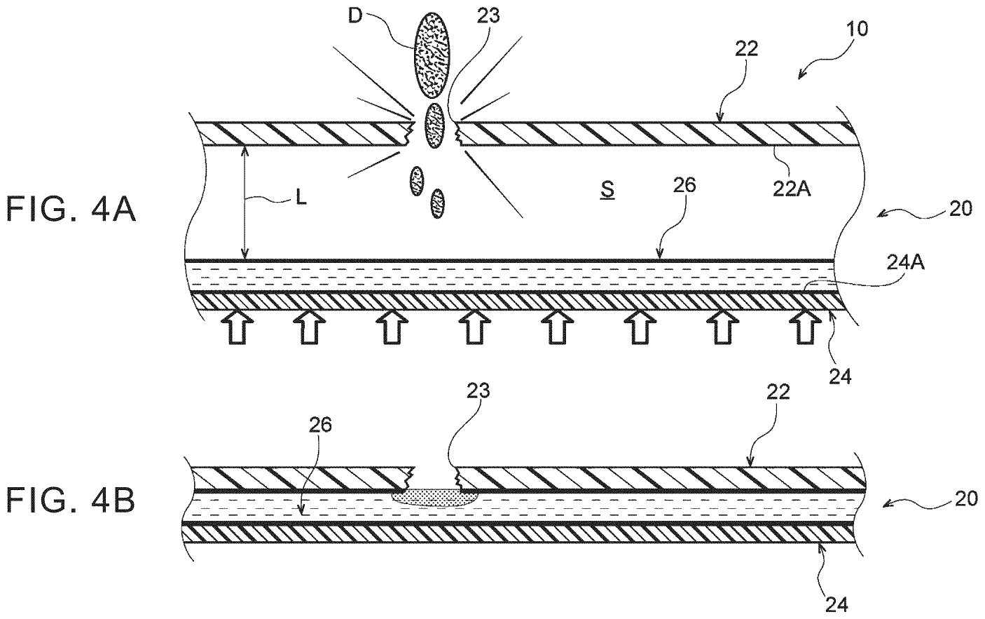

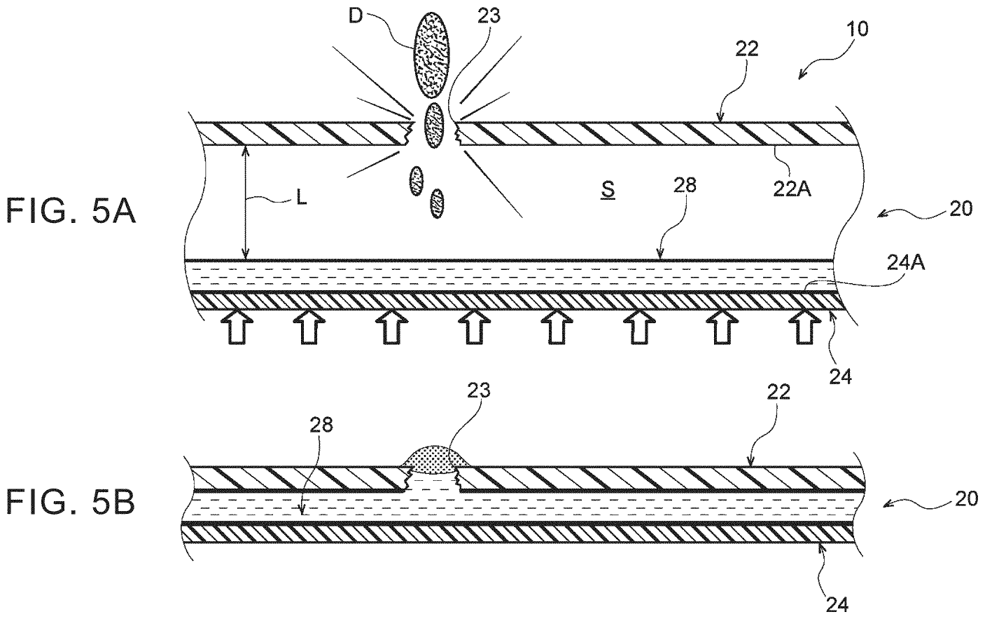

Further, the second panel member 24 includes a protective film 30 made of resin. Specifically, as shown in FIG. 3, the second panel member 24 is configured such that the protective film reinforcing layer 32 is laminated on the vehicle inner side of the protective film 30, the touch panel film 34 is laminated on the vehicle inner side of the protective film reinforcing layer 32, and the duct tape 36 is laminated on the vehicle outer side of the protective film 30.

The protective film 30 is, for example, a fluororesin film such as polytetrafluoroethylene, and has heat resistance and cryogenic resistance. The protective film reinforcing layer 32 is, for example, Kevlar (registered trademark), and has high strength and high heat resistance. The duct tape 36 is a high-strength adhesive tape and has a high adhesive strength.

The touch panel film 34 is pressure sensitive. As will be described later, when the hole 23 (see 2A of the drawing) is opened in the first panel member 22 and the hole 23 is closed by the second panel member 24, the occupant can recognize where the hole 23 is opened in the first panel member 22. That is, the touch panel film 34, the occupant is provided to recognize where the hole 23 of the first panel member 22 is opened.

Note that the second panel member 24 may be formed of only the protective film 30 Further, the second panel member 24 may be composed only of the protective film 30 and the protective film reinforcing layer 32 Further, the second panel member 24 may include only the protective film 30, the protective film reinforcing layer 32, and the touch panel film 34, or may include only the protective film 30, the protective film reinforcing layer 32, and the duct tape 36.

Further, as shown in 2A, in a normal state, the second panel member 24 is disposed away from (in non-contact with) the first panel member 22. In other words, between the first panel member 22 and the second panel member 24, the space portion S of a predetermined interval L along the thickness direction of the first panel member 22 and the second panel member 24 is formed. This is because even if the hole 23 is opened in the first panel member 22 hits debris D or the like from the outside of the vehicle to the first panel member 22, the second panel member 24 so as not to open the hole.

Then, hit debris D or the like from the outside of the vehicle to the first panel member 22, when the hole 23 in the first panel member 22 is opened by the debris D or the like, by the pressure of the vehicle interior (cabin 14), the second panel member 24 is adapted to move immediately to the first panel member 22 side. That is, as shown in 2B, the outer surface 24A of the second panel member 24 is brought into close contact with the inner surface 22A of the first panel member 22, so as to immediately close the hole 23.

Next, an operation of the vehicle body structure 10 according to the present embodiment configured as described above will be described.

The rover 12 runs on a thin planet of the atmosphere, for example, the surface of the moon or the surface of Mars. Therefore, debris D, meteorite, and the like are easily poured onto the outer wall of the cabin 14. Therefore, the first panel member 22 constituting the outer wall of the cabin 14, there is a possibility that the hole 23 is opened by the debris D or the like. If the hole 23 is relatively large, the cabin 14 is depressurized at once due to the pressure difference between the inside and outside of the vehicle, the life of the occupant in the cabin 14 is threatened.

Therefore, in the vehicle body structure 10 according to the present embodiment, the second panel member 24 is disposed on the vehicle inner side of the first panel member 22. Further, between the first panel member 22 and the second panel member 24 is provided with a space portion S. That is, the second panel member 24, to immediately repair the outer wall of the cabin 14 by closing the hole 23 automatically, so that it is possible to reduce the damage to the occupant caused by the rapid depressurization. Hereinafter, description will be given.

As shown in FIG. 2A, when the debris D hits the outer wall of the cabin 14 the hole 23 in the first panel member 22 is opened, the space portion S is communicated with the outside of the vehicle. Therefore, the pressure of the space portion S is reduced. Therefore, the pressure in the cabin 14, at least a portion of the second panel member 24 (the portion facing in the hole 23 and the interval L direction) is moved to approach the first panel member 22.

At least a portion of the second panel member 24 moved so as to approach the first panel member 22, as shown in 2B, the outer surface 24A (see 2A) contacts and closely contacts the inner surface 22A of the first panel member 22 (see 2A), and closes the hole 23. Accordingly, the outer wall (the first panel member 22) of the cabin 14 is automatically repaired by at least a portion of the second panel member 24. Therefore, it is possible to suppress the occupant does not need to perform such work as closing the hole 23 exits the vehicle outside, to suppress a decrease in the protective performance of the first panel member 22.

Further, with such a configuration, as compared with the case of ensuring the protective performance by thicker forming the plate thickness of the first panel member 22, it is possible to reduce the weight of the first panel member 22. In addition, since the second panel member 24 includes the protective film 30 made of resin, the second panel member 24 can be made lighter in weight than in the case where the second panel member 24 is made of, for example, an iron plate. That is, it is possible to reduce the weight of the entire panel member 20 covering the cabin 14.

Further, when the protective film reinforcing layer 32 on the vehicle inner side of the protective film 30 of the second panel member 24 is laminated, while reducing the weight of the second panel member 24, it is possible to improve the strength of the second panel member 24. In addition, when the touch panel film 34 is provided on the vehicle inside of the protective film 30 (specifically, the protective film reinforcing layer 32) of the second panel member 24, it is possible for the occupant to recognize where the hole 23 is opened.

Further, when the duct tape 36 on the vehicle outer side of the protective film 30 of the second panel member 24 is laminated, the inner surface 22A of the first panel member 22, the outer surface 24A of the second panel member 24, i.e. the duct tape 36 can be brought into close contact with non-peelable. Therefore, for example, even if the vehicle (cabin 14) is depressurized, without a portion of the second panel member 24 closing the hole 23 is moved to the vehicle inside, the hole 23 is opened again it is possible to suppress the occurrence of a problem such as.

As shown in 4A, the liquid layer 26 may be provided on the vehicle outer side of the second panel member 24. This liquid layer 26 is constituted of a liquid-like adhesive which solidifies when cooled, and the illustrated one is laminated on the outer surface 24A of the second panel member 24. That is, a space portion S having a predetermined interval L is formed between the first panel member 22 and the liquid layer 26.

When such a liquid layer 26 is provided on the vehicle outer side of the second panel member 24, a hole 23 is opened in the first panel member 22, and when the second panel member 24 moves so as to approach the first panel member 22 by the pressurization in the cabin 14, a part of the liquid layer 26 contacts the periphery of the hole 23 as shown in 4B. At least a part of the liquid layer 26 exposed from the hole 23 is immediately cooled and solidified by the low-temperature environment outside the vehicle, and the hole 23 is automatically closed from the inside of the vehicle.

Accordingly, the outer wall (the first panel member 22) of the cabin 14 is automatically repaired by at least a portion of the liquid layer 26. Therefore, in the same manner as described above, it is not necessary to perform the work such that the occupant closes the hole 23 exits the vehicle outside, it is possible to suppress a decrease in the protective performance of the first panel member 22.

Further, as shown in 5A, the liquid layer 28 may be provided on the vehicle outer side of the second panel member 24. The liquid-layer 28 is made of water, and the illustrated liquid layer is laminated on the outer surface 24A of the second panel member 24. That is, a space portion S having a predetermined interval L is formed between the first panel member 22 and the liquid layer 28.

When such a liquid layer 28 is provided on the vehicle outer side of the second panel member 24, a hole 23 is opened in the first panel member 22, and when the second panel member 24 moves so as to approach the first panel member 22 by the pressurization in the cabin 14, as shown in 5B, a part of the liquid layer 28 leaks out of the vehicle from the hole 23. However, since a part of the leaked liquid layer 28 is water, the water is immediately cooled and solidified (becomes ice) by the low-temperature environment outside the vehicle, and the hole 23 is automatically blocked from the outside of the vehicle.

Accordingly, the outer wall (the first panel member 22) of the cabin 14 is automatically repaired by at least a portion of the liquid layer 28. Therefore, in the same manner as described above, it is not necessary to perform the work such that the occupant closes the hole 23 exits the vehicle outside, it is possible to suppress a decrease in the protective performance of the first panel member 22.

Although the vehicle body structure 10 according to the present embodiment has been described with reference to the drawings, the vehicle body structure 10 according to the present embodiment is not limited to the illustrated one, and can be appropriately changed in design without departing from the gist of the present disclosure. For example, the vehicle is not limited to the rover 12 used on the lunar surface or the like. The vehicle body structure 10 according to the present embodiment can also be applied to vehicles used in low temperature environments and in certain areas of the Earth where the atmospheric pressure is low.

What is claimed is:

1. A vehicle body structure comprising:
a first panel member constituting an outer wall that faces outside a vehicle; and
a second panel member that is positioned on a vehicle inner side of the first panel member such that a space is provided between the first panel member and the second panel member and that is configured, when a hole is made in the first panel member, to come into contact with the first panel member with a pressure inside the vehicle to close the hole.

2. The vehicle body structure according to claim 1, wherein the second panel members includes a protective film made from resin.

3. The vehicle body structure according to claim 1, further comprising a liquid layer provided on a vehicle outer side of the second panel member.

4. A vehicle comprising the vehicle body structure according to claim 1 and used on a ground surface other than Earth.
